(19) United States
(12) Patent Application Publication
(10) Pub. No.: US 2007/0265006 A1
(43) Pub. Date: Nov. 15, 2007

(54) Interactive text messaging system for information distribution

(76) Inventors: James Edward Washok, Richmond, VA (US); Chris Michael Littleton, Midlothian, VA (US)

Correspondence Address: CHARLES T. JOYNER, PLLC, 7515 JOHNSON MILL ROAD, BAHAMA, NC, 27503, US

(21) Appl. No.: 11/801,065

(22) Filed: May 8, 2007

Related U.S. Application Data
(60) Provisional application No. 60/813,111, filed on Jul. 12, 2006.
(60) Provisional application No. 60/798,814, filed on May 9, 2006.

(51) Int. Cl. H04Q 7/20

(52) U.S. Cl. 455/435.1

(57) ABSTRACT

The present invention relates to a system and method of interactive telecommunication text and multimedia messaging whereby an individual user may indicate interest in products or services and receive multimedia content that may facilitate acquiring those products or services. This invention is particularly suited to mobile telecommunication devices.

### RELATED APPLICATIONS

This application claims priority under 35 U.S.C. § 119(e) to U.S. provisional application Ser. No. 60/813,111, filed Sep. 12, 2006, and U.S. provisional application Ser. No. 60/798,814, filed May 9, 2006, both of which are incorporated herein by reference.

### FIELD OF THE INVENTION

The present invention relates to methods of electronic commerce using mobile, wireless communication devices.

### BACKGROUND OF THE INVENTION

The advent of the internet and the cellular mobile phone in the late twentieth century heralded a revolution in telecommunications that is continuing at a rapid pace to the present. The internet has had a dramatic impact on commerce throughout the world, and has spawned a multitude of new enterprises that facilitate the purchase of goods and services. Likewise, the mobile phone has brought unimagined changes that have touched all aspects of our economy. Further, the integration of graphic displays, cameras, and computer functions into mobile phones has taken them well beyond simple voice communication instruments. Transmission of text messages and photographs are becoming increasingly popular especially with the younger users.

The potential of mobile cell phones and related wireless communication devices as instruments for providing real time information about goods and services to the consuming public is just beginning to be explored. Currently it is possible to send a coded text message and receive commercial and noncommercial information in text or graphic form. However, the information is still rather limited. Mobile phones and related wireless mobile telecommunication devices need an improved system of distributing this information that is versatile and easy to use.

### SUMMARY OF THE INVENTION

The first aspect of the present invention is a system of interactive telecommunication text and multimedia messaging whereby an individual user may indicate interest in products or services and receive multimedia content that may facilitate acquiring those products or services. The system comprises:
one or more implementing servers coupled to a wide area computer network,
one or more databases and means for storing keyword-related, code-related, or free-form request information in one, all, or any combination of the databases,
optionally, one or more websites to furnish additional information to the individual user,
one or more mobile telecommunication devices coupled to one or more mobile telecommunication networks capable of capturing, transmitting and receiving data input by means of keypad, voice, camera, microphone, and scanner, as well as other input devices activated by motion, external environmental conditions, touch, personal area wireless network technology, or any combination thereof, and

optionally, one or more intelligence algorithms to impart search engine capability.

The second aspect of the present invention is a method for interactively providing text and multimedia messaging of information to a user of the system of the first aspect. The method comprises the steps of:
Informing the user of information relating to a product or a service available on a service provider's server or servers,
providing a short code or phone number to access that information from a mobile telecommunication device and a keyword, or other code, to identify the particular product or service,
receiving at the service provider's server or servers a request for the information in the form of the provided short code and keyword or other code from a user interested in obtaining the information,
transmitting from provider's server or servers to the mobile device of the user the requested information in its most current version as a text or multimedia message,
implementing one or more servers coupled to the Internet for receiving the keyword or other code from the input mobile device of the user to return appropriate information content, and
optionally, comprising the additional step of personalizing or customizing the text or multimedia output based on historical, current behavioral, demographic or commercial data or any combination thereof available to the service provider based on the user initiating communications.

The third aspect of the present invention is an extension of the system of interactive telecommunication text and multimedia messaging of the first aspect whereby a user may purchase products or services instantly using their mobile device. The system further comprises:
one or more application programming interfaces for exchanging sales order, billing and shipping information to/from the vendor of a product or service available for purchase, and
at least one means for the consumer to indicate desire to make a purchase via their mobile device, to authenticate their identity and authority to purchase, to optionally identify preferred payment method, to optionally adjust preferred shipping destination, and to receive confirmation of order fulfillment.

The fourth aspect of the present invention is a system of interactive telecommunication text and multimedia messaging whereby a user may supply and/or receive content as part of a text message based blog or wiki of public or community information. The system comprises:
one or more implementing servers coupled to a wide area computer network,
one or more databases and means for storing keyword-related information in one, all or any combination of the databases,
one or more websites to furnish additional information to the individual user,
one or more websites for blog, wiki, community, and alert settings management
one or more mobile telecommunication devices coupled to one or more mobile telecommunication networks capable of capturing, transmitting and receiving data input by means of keypad, camera, microphone, scanner, motion, external environmental conditions, touch, personal area wireless network technology, or any combination thereof.

The fifth aspect of the present invention is a personal or group text messaging system involving interactive telecommunication text and multimedia messaging whereby an individual user may indicate interest in and/or communicating with another individual by texting a keyword and short code combination displayed on personal business cards; apparel; bumper stickers; general outdoor advertisements, such as billboards, posters, roadside signs; and aerial displays; electronic displays, such as television, computer and telephone screens; notepads; and other similar visual communicative devices as well as those cited in traditional print media, such as newspapers, magazines and flyers. The system comprises:
Multiple copyrighted personal business card designs and artwork uploaded by users bearing a user's personal keyword and the service provider's short code,
one or more implementing servers coupled to a wide area computer network,
one or more databases and means for storing keyword-related information in one, all or any combination of the databases,
one or more websites for individual users to manage their text messaging account and to furnish additional information to responding individual users.
one or more mobile telecommunication devices coupled to one or more mobile telecommunication networks capable of capturing, transmitting and receiving data input by means of keypad, camera, microphone, scanner, motion, external environmental conditions, touch, personal area wireless network technology, or any combination thereof.

### BRIEF DESCRIPTION OF THE DRAWINGS

FIG. 1 is a schematic overview of the method of the present invention.

FIGS. 2-6 are schematic flow charts illustrating in detail examples of the embodiments of the present invention.

### DETAILED DESCRIPTION OF THE INVENTION

### Definitions

As used herein, the terms below have the following meanings: “SMS” means “Short Message Service,” is synonymous with “texting” or “text messaging” and is the technological system established by the wireless carrier industry for transmission of text based messages.

“MMS” means “Multimedia Message Service” and is the technological system established by the wireless carrier industry for transmission of multimedia based messages containing or triggering the input and/or output of images, video, audio, odors, or tactile feedback.

“Modules,” as used herein, correspond to embodiments of the invention.

“Text” (as noun) as used herein unless otherwise noted, includes alphanumeric characters, words, and symbols.

“To text message,” “text” (as verb) or “texting” is the act of sending a text or multimedia message via a mobile telecommunication device.

“Blog” refers to a web-based publication of periodic articles, usually in a reverse chronological, journal-like format that may contain text, images, videos, audio and links to other sites and can be easily created by anyone with a internet-connected computing device. This term is also used as verb meaning to create and/or to maintain a blog.

“RSS” means “Real Simple Syndication” and is a suite of web feed formats, specified in XML, used for the syndication of content on the internet, especially news and blogs, and can be subscribed to using client or server based software that automatically retrieves updated content.

“Wiki” is a type of web site that allows users to quickly and easily add publicly valuable and accessible information, update and delete content, often without the need for registration, in an advanced form of collaborative writing

“TXTblog” or “TXTrss” refers an implementation of blogging and RSS by the present invention that allows one or more authorized individuals to submit blog content using text messaging, thus making the blog entries very short snippets, to which other mobile users can subscribe to receive instantly whenever a new post is provided to the system and may be permitted to respond to as a public comment. A companion web site may be available to display the history of posts for later review. “TXTwiki” is an implementation of a wiki by the present invention that allows any person to add, update and delete content that will be instantly sent to subscribers of the TXTwiki whenever they submit a keyword that identifies the wiki by a previously provided short code. For example, community news may include upcoming events and local sports scores that members of the community can update online and retrieve by text messaging.

“Mobisode” means a television-like series of video content made specifically for or ported to viewing on mobile devices.

“Podcast” means a multimedia file distributed over the internet using RSS feeds for playback on personal computers or mobile devices allowing the consumer of the file to access the content whenever and wherever preferred.

“Podisode”—a podcast, primarily consisting of a video format, that is part of a planned series specifically designed for viewing on mobile devices.

“Short code” is an exclusive numerical identifier on the wireless telecom system to which text and multimedia messages are addressed and routed to the appropriate service provider.

A “mobile telecommunication device,” or simply “mobile device,” is any portable electronic telecommunication instrument capable of transmitting and receiving text and/or multimedia messages and/or content. Such devices include, but are not limited to, cell phones and wireless PDAs, smartphones, Blackberries (trademark of Research in Motion, Ltd. for hand-held computer/phone devices), and certain other mobile digital devices capable of transmitting over wireless networks. The terms “mobile” and “wireless” are synonymous as used herein.

“Mobile user” or “user” is a mobile telecommunication device user.

“Advertisement” or “ad” as used herein, includes the usual meaning, i.e., a commercial announcement, as well as a non-commercial or public interest announcement

“Advertising business,” “advertiser,” or “business” is an organization seeking interaction with users. As used herein, these terms also include non-commercial and public interest organizations

“Keyword” as used herein means an alphanumeric expression assigned to uniquely identify an advertiser, product, service or event.

“Short code” or “Common Short Code” refers to the system of numeric addresses, similar to phone numbers, established within the national cellular infrastructure and maintained by NeuStar, Inc. (trademark) to which text and multimedia messages can be addressed for transmission to the appropriate service provider. Short codes are currently 5 and 6 digits in length.

“Code” refers to any alphanumeric (also known as “keyword”), graphical (2D code, UPC, image of an object, etc) or sensory-like (motion, scent, sound, etc) that is used to identify what the mobile user has interest in

“Service provider,” “provider,” or “interactive multimedia message manager (IMMM) is the organization that facilitates interaction and communication between the advertising business and the user of such OTAir, LLC (trademark), Richmond, Va. The service provider is the host of the invention's implementation. A content provider furnishes the content output to the mobile user via connection to the service provider. The content provider may or may not also be the service provider. However, as used herein, unless note otherwise, the service provider is also the content provider.

A “server” is a high speed, high capacity computer system operated by the service provider and content provider and connected to the internet.

“Internet” as used herein is a form of a global wide area computer network.

### EMBODIMENTS

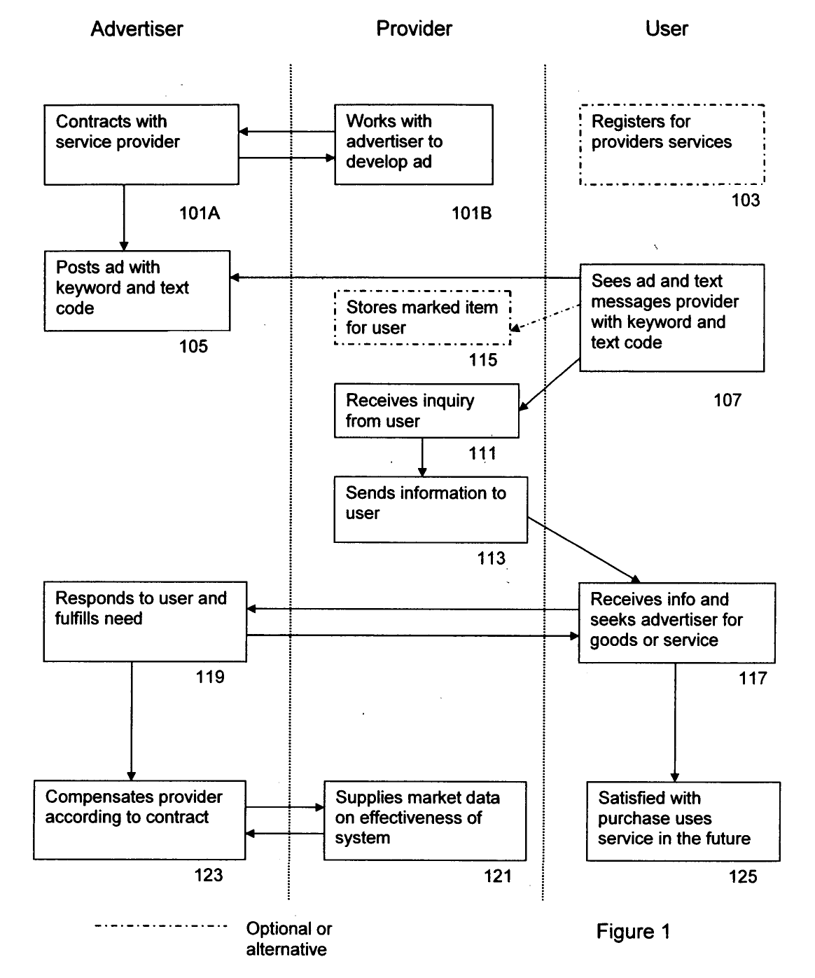

In FIG. 1, an abbreviated overview of the method of the present invention, an advertiser contracts with a service provider, who in turn, works with the advertiser to develop and an advertisement, i.e., the relationship between 101A and 101B. A mobile telecommunication device user, i.e., “mobile user” or “user,” optionally may register with the provider for additional services (103). The advertiser posts the ad developed jointly with the provider. The posting (105) may be in a physical or print form, such as on a billboard or newspaper, or electronically, such as on television or the internet.

The user sees the ad, is interested in the advertiser's offering (107), and sends a text message to the provider via, the short code and citing the keyword provided in the ad. The server of the provider receives the inquiry from the user (111), and sends the information supplied by the advertiser to the user (113). Alternatively, the user who had previously registered with the provider, (as indicated by 103, could “mark” the ads that interested him or her for future reference. The user might wish to study the advertiser's offer at a later time by logging onto the provider's website. Optionally, registered users could establish a sub-site on the provider's website where information relating to their marks would be stored (115).

The user receives information and promotional material from provider's server, is interested in the advertiser's offer, and seeks the advertiser for the goods or service (117). The advertiser responds to the user, honors any special agreements such as discount coupons offered, and fulfills the user's needs (119). In the broadcast embodiment, the message of the organization sponsoring the broadcast is sent to the user.

The provider supplies the advertiser with useful marketing data such as the number of inquires generated by the ad and the time of day (121). In turn, the advertiser compensates the provider according the contract (123). The user, satisfied with the goods or services purchased from the advertiser is likely to use the provider's service in the future (125).

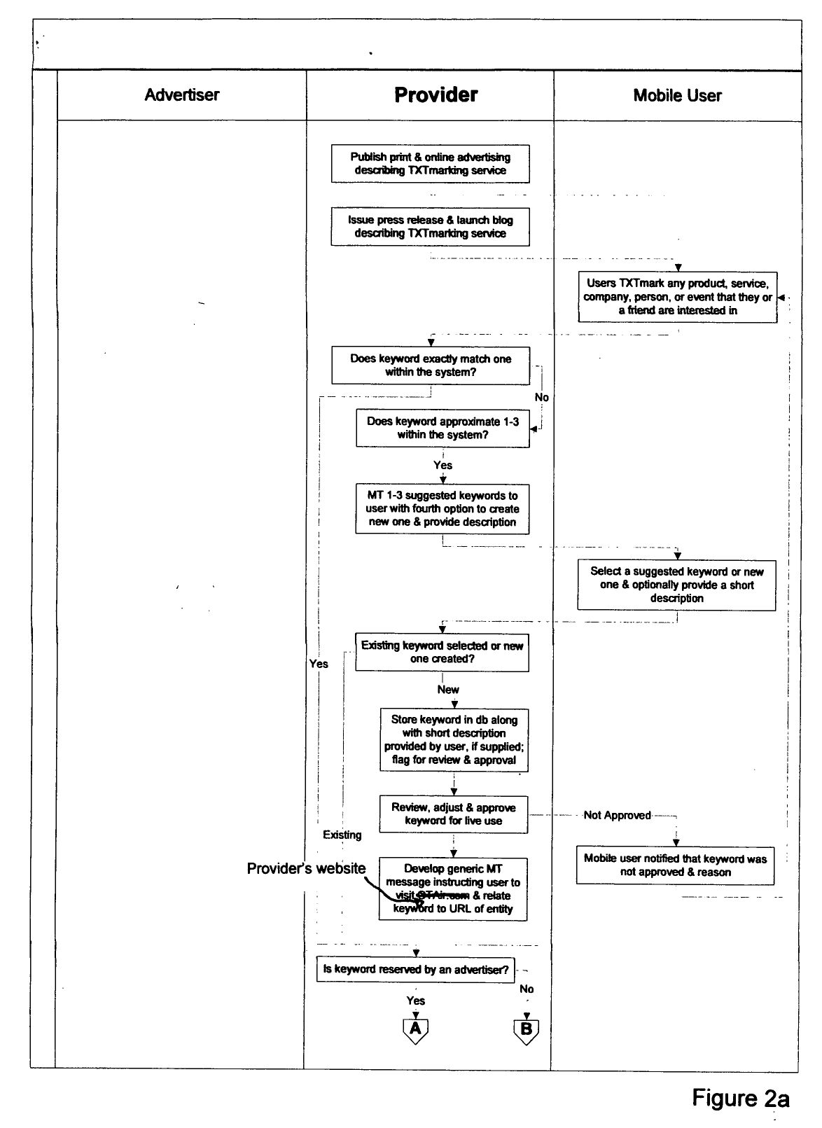

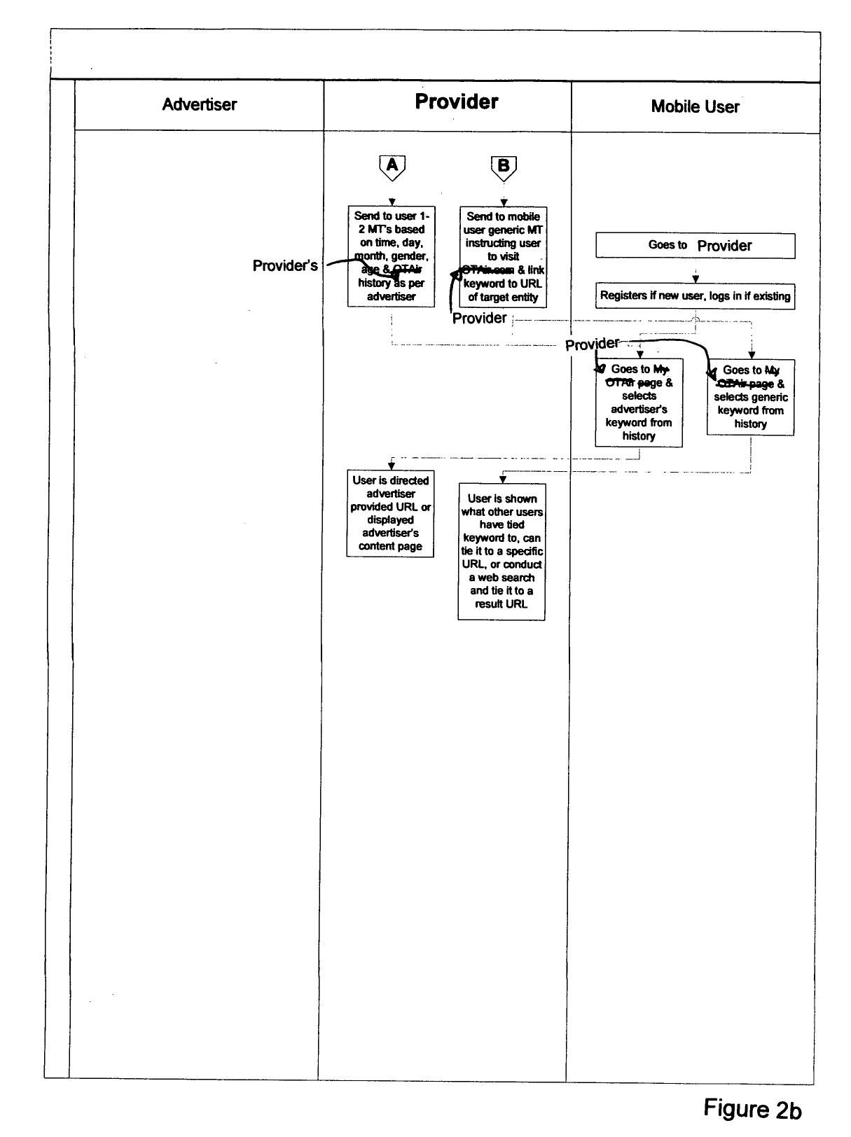

In one embodiment, exemplified in FIGS. 2a and b, the reader, i.e., potential user, is made aware of a product or service through print and electronic advertising and is provided a short code and a keyword. The advertisement might direct the user, to send the stated keyword to the stated short code to learn the specialties of the day, product information, nearest location of the advertising business, purchase the product immediately, and/or to receive a discount coupon. The interested user text messages the short code to the stated number, which is the server of the service provider. This action by the user is referred to herein as “Message Origination” (MO).

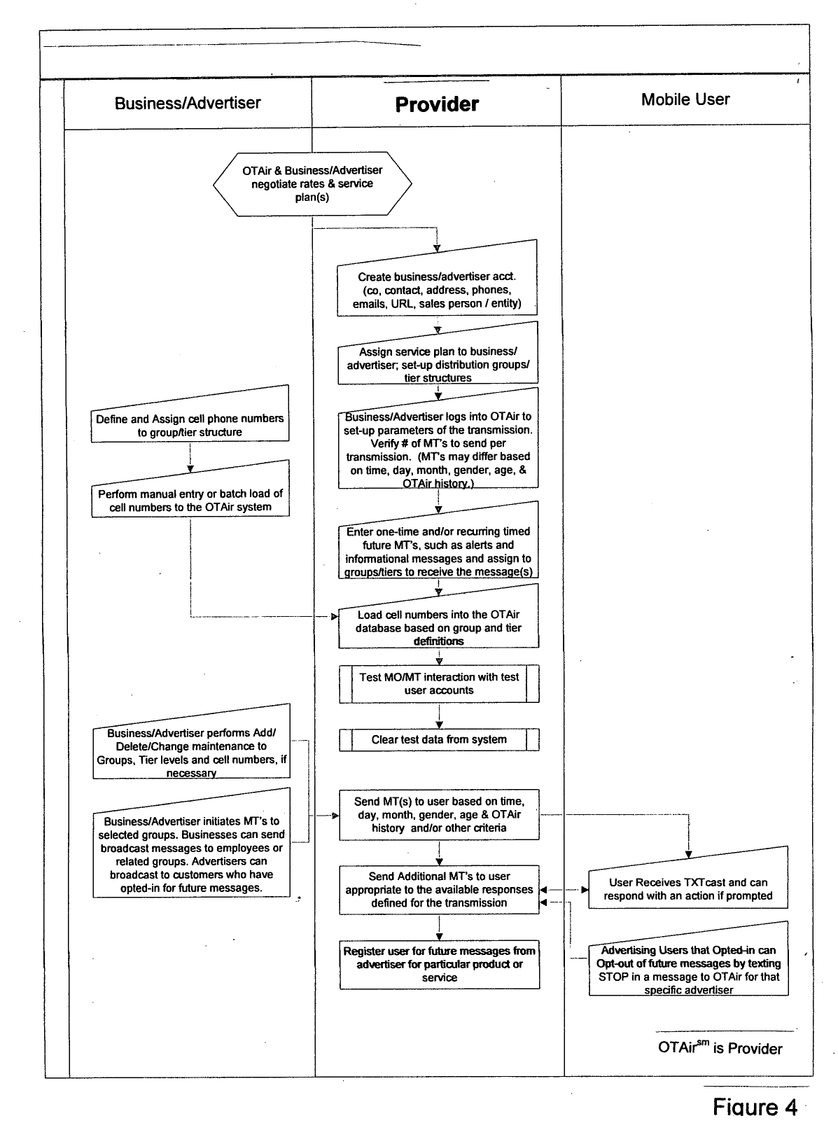

Upon receipt of the keyword from the user, the provider's server sends a message to the user's device, such as a cell phone. The message may be text, an image, a web link, a sound, a video, a scent, a tactile stimulus or a combination. As used in FIGS. 2-6 this action is referred to as “Message Termination” (MT). The user may store the message in her device for later use as an electronic voucher. Of course, the exact content of the message regarding the location of the advertising business would vary with the location of the user at the time a short code was transmitted to the server, but may also vary according to day time, events, environmental conditions or any demographical characteristic applicable to the user. Optionally, users can register with the provider and receive messages according to their taste and interest.

In the case of a restaurant, for example, the text sent to the user might be directions to the restaurant (or the closest location if it is a chain of restaurants) and a coupon displayed on the mobile device offering an attractive discount for a certain period of time. Likewise, an advertiser selling shoes many offer a very enticing discount during the hour when business is slow.

As a further example, Max Burger House, a fast food restaurant, might have an advertisement on a street side billboard giving a short code and keyword, “Max”. It is 11:30 am and Mary, going to lunch, sees the advertisement, and wonders what deals Max is offering today. Upon text messaging the server via her cell phone using the short code and keyword shown on the advertisement, she receives a return text message stating, The closest Max's to you is at the corner of 2^{nd} and Marvin St. Show this message when placing your order, and get our lunch time special of two-for-the-price-of-one on any item on the menu.” This offer is good until 4 o'clock today.” She then stores the text message in her cell phone for presentation at the restaurant to claim the lunch time special offer. After 4 o'clock, Max's might offer a dinner time special to users text messaging the provider's server.

Further, Mary may wish to register with the provider noting that she would like text messages from restaurants in her area from 9:00 to noon, Monday through Friday. Likewise, a cell phone user might wish to be informed each Thursday of Italian restaurants offering dinner specials.

In another variation of this embodiment, aerial advertising signage, e.g., via airplane and helicopter banners, blimps, digital airships, skywriting, kites, land-based spotlights and land-based projected holographic images, is employed. The aerial advertisements would engage a viewer to become a user by texting a keyword to the Service provider's short code. The user would then receive a text and/or video message on their cell phone with the message that the aerial advertiser chose to present to the respondent. The present invention provides a means of individual interactivity of presenting textual information, pictures and video on an individual's cell phone that is initiated by aerial advertising.

An example of aerial advertising signage would be an airplane pulled banner advertising a seafood restaurant displaying a logo or other trademark followed by a streamer banner bearing the words “Text CRAB to 68247”. The interested party would see the aerial ad, express interest based on the aerial presentation, and then initiate the action of texting CRAB to 68247. A response would be returned to the user's cell phone using a media type defined by the advertiser. The user could then interact again using a text message command to get more information from the advertiser or have the advertiser get in touch with the user directly.

In a similar manner as described above for aerial advertising signage, general and outdoor advertising may be used to attract users. Examples of general and outdoor advertising include, but are not limited to, airport advertising, banners & wallscapes, bicycle displays, billboards, building illumination, bus advertising, cinema ads, commuter rail, electronic signs and billboards, gas station ads, hotel campaigns, mall displays, mobile billboards, mobile projection, phone kiosks, posters, recruitment campaigns, scooter caravans, shuttle bus programs, sports marketing, street teams, taxi advertising, transit shelters, video display vehicles, video mobile billboards, wrapped smart cars, wrapped vehicles.

In another variation, advertising is printed on clothing and luggage (T-shirts, hand bags, hats, shoes, jackets, coats, luggage, and backpacks). The clothing and luggage ads would engage a viewer to text a keyword to the Service provider's short code. The user would then receive a text and/or video message on their cell phone with the message that the advertiser chose to present to the respondent. The Present invention is to initiate a means of individual interactivity of presenting textual information, pictures and video on an individual's cell phone that is initiated by a TXTtag call to action printed on clothing and luggage.

For example, on a T-shirt is imprinted the message “For Discounts, Text Nike to 68247”. As in the example above, an interested party seeing the ad, texts “Nike to 68247.” A response would be returned to the respondent's cell phone using a media type defined by the advertiser. The respondent could then interact again using a text message command to get more information from the advertiser or have the advertiser get in touch with the respondent directly.

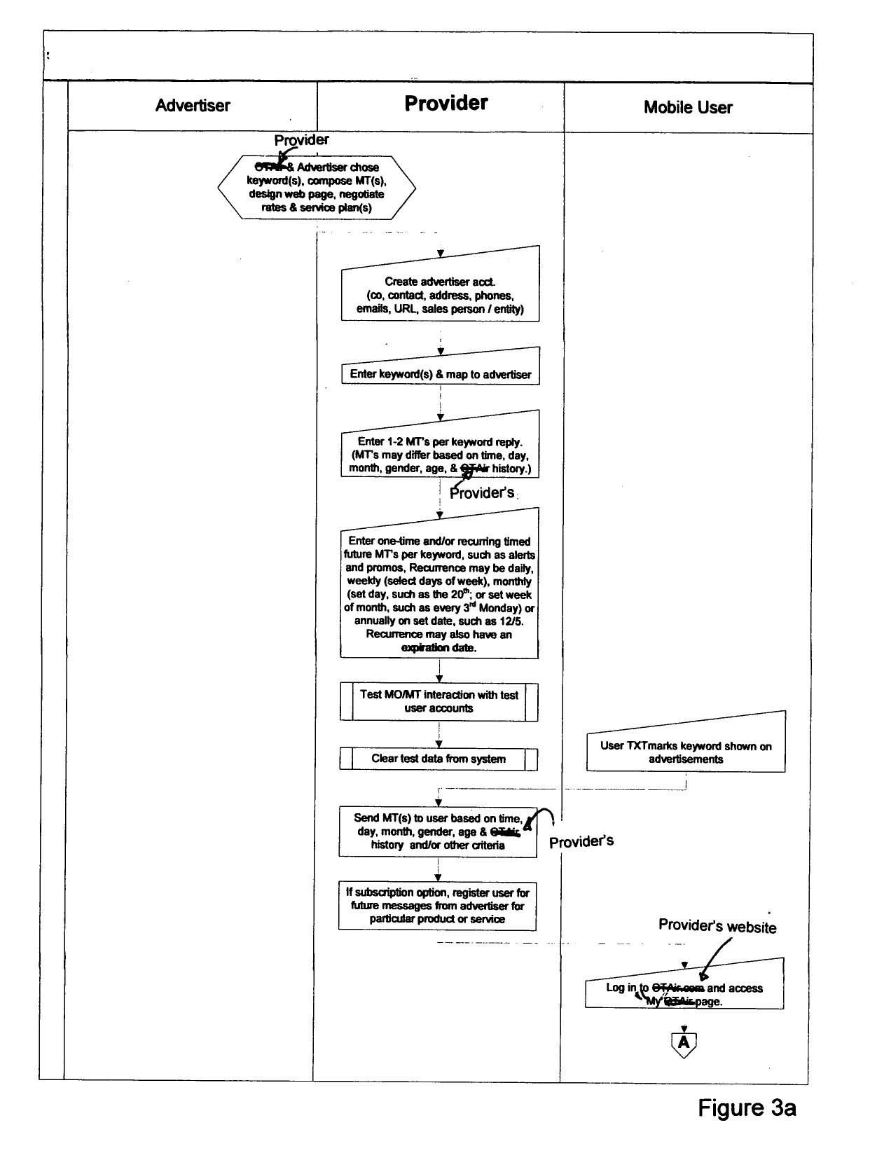

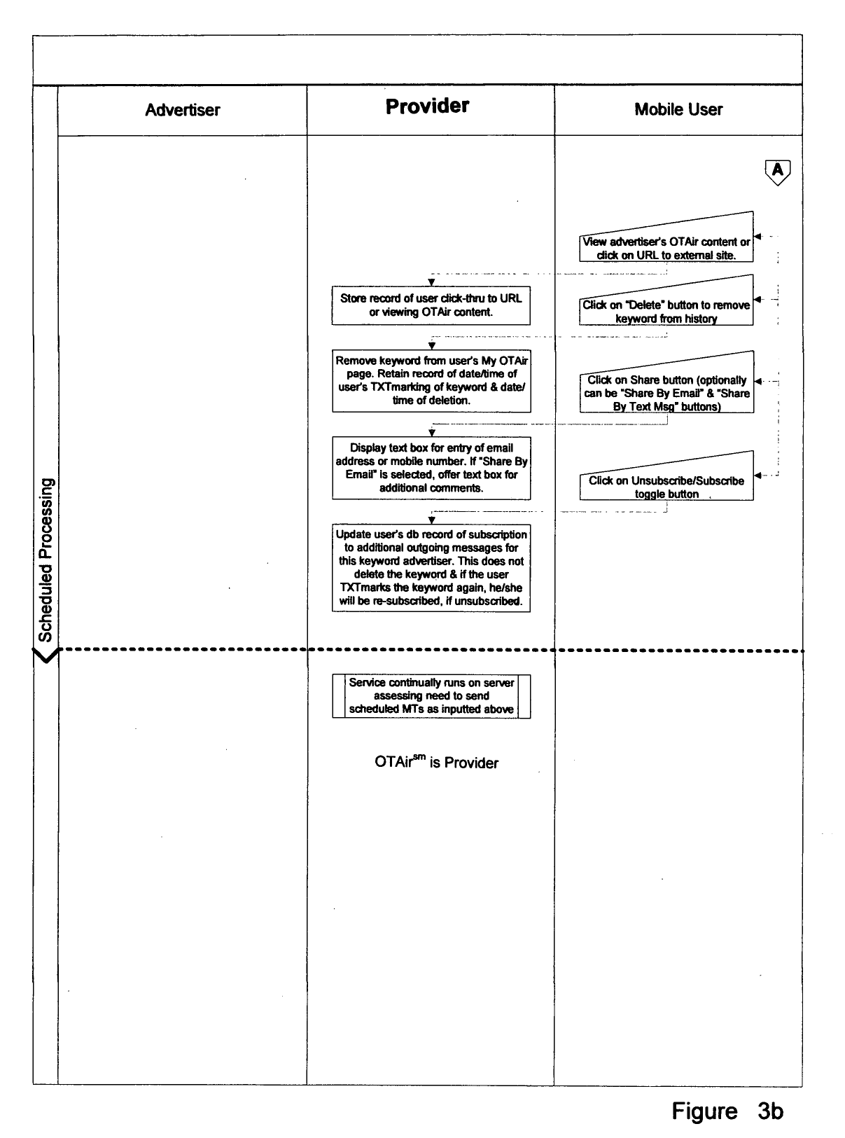

In another embodiment, the present invention may be used to provide information about a product that would traditionally or conveniently be given in an advertisement. A business might have a short code and keyword displayed in its advertisements or on its employees' business cards. An interested mobile device user might send a text message to the provider's server and receive text message inquiring about which product the user was interested. The user would make a selection and receive details on the product offered for sale. The details of the above embodiment are presented in graphic form in FIGS. 3a-b and 4.

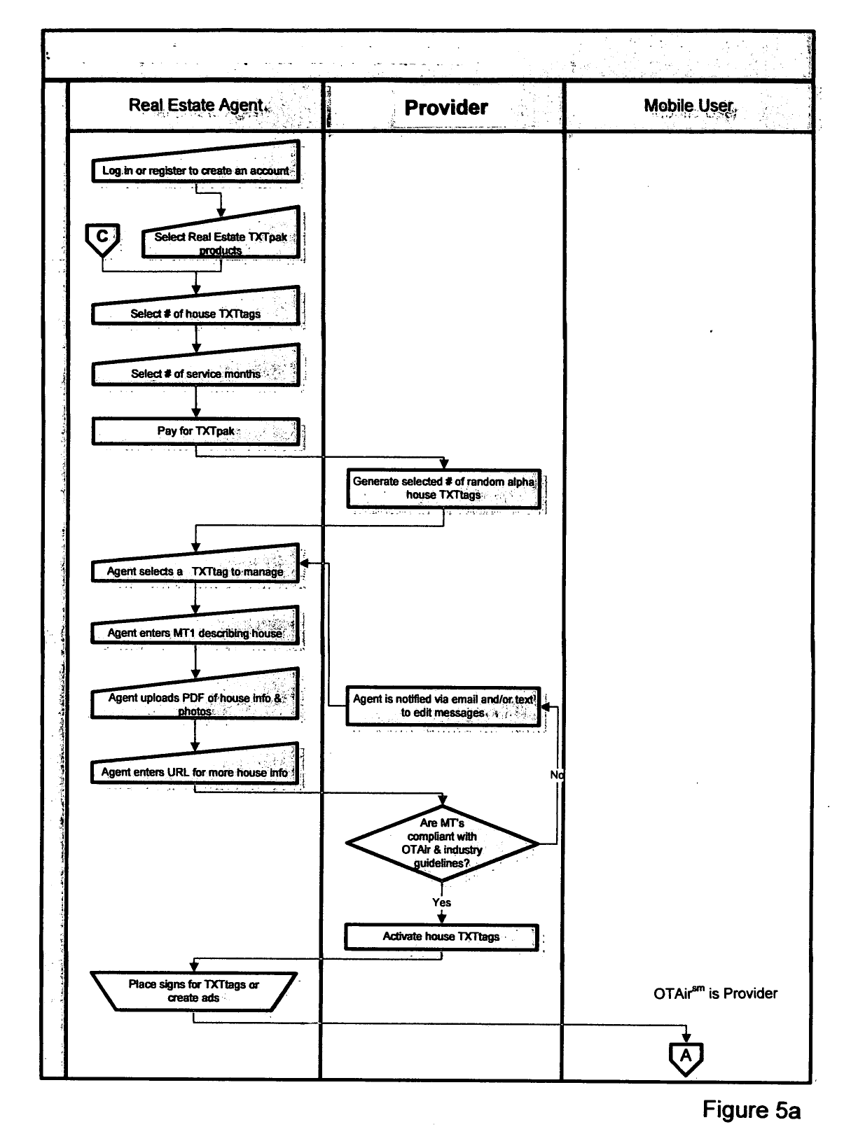

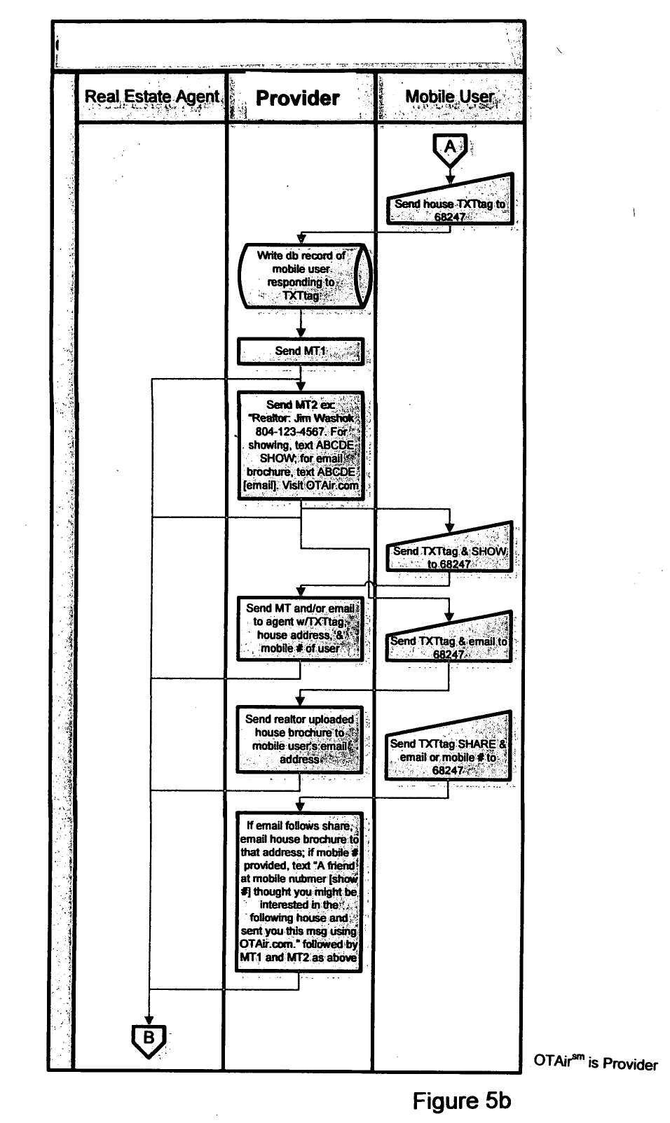

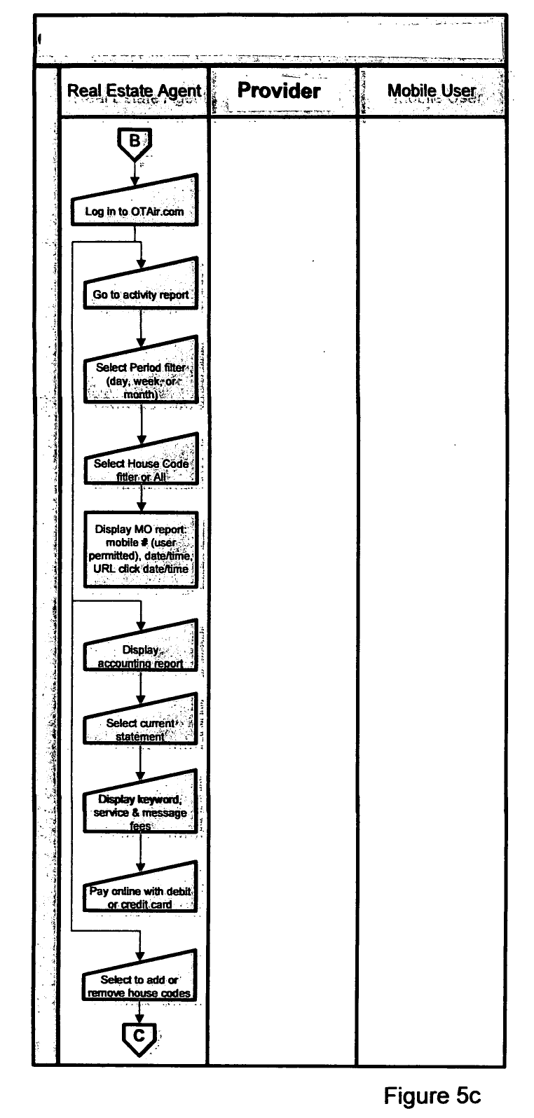

In particular, the present invention is useful to realtors. For example, a realtor places a unique keyword for the house and a short code on his sign in front of a house he has just listed. The details of this example are graphically presented in FIGS. 5a-c. A potential buyer driving by likes the house from the outside, but would only be seriously interested in buying if it had four bedrooms. Text messaging the keyword to the short code returns to the cell phone potential buyer, i.e., user, detailed house specifications, realtor info, schedules a showing, or emails the user a brochure about the house including photographs of the interior.

In a similar manner as described in the previous paragraph, the present invention may be used to promote the sale of new and used motor vehicles, watercraft, farm machinery, and the like. Just as a sign may be placed in front of a house, a sign may be placed in the window of, or attached to, a vehicle or watercraft being offered for sale. Just as a prospective realestate buyer is directed by the sign to text a keyword to a short code, a vehicle or watercraft buyer would be given a keyword and short code to use to receive more information.

For example, for an individual wishing to sell her used car, a service provider might supply a keyword and short code that the individual could add to a “For Safe” sign posted in the car's window. A potential buyer could text the keyword to the provider's short code to receive more information. The same approach would be equally useful to a vehicle dealer.

The present invention is also useful for job postings. For example, a business or employment agency might publish a list of job openings on the internet, newspapers, bulletin boards, etc giving a keyword for each posted job and the service provider's short code. As with the real-estate application above, a person seeking a job could quickly and easily learn the details of posted jobs by texting the job's key word to the short code.

In yet another embodiment, the present invention may be used to broadcast informational or entertainment content to a plurality of mobile device users. As in the two above cited embodiments, each user text messages a server with the keyword and short code combination assigned to the desired content. By return messaging, each user receives the desired content, which may or may not be specifically tailored for his use. Optionally, access to the content may be by prepaid or concurrently paid subscription. Also optionally, receipt of the content may be password protected.

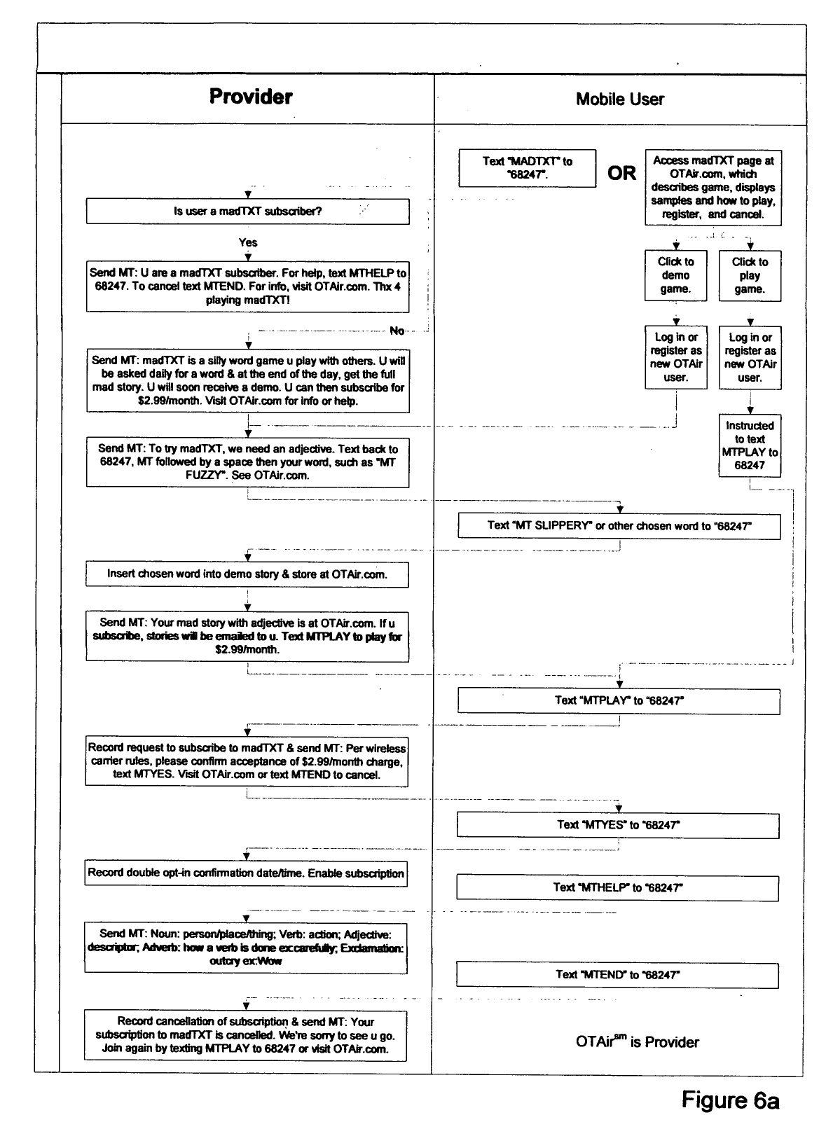

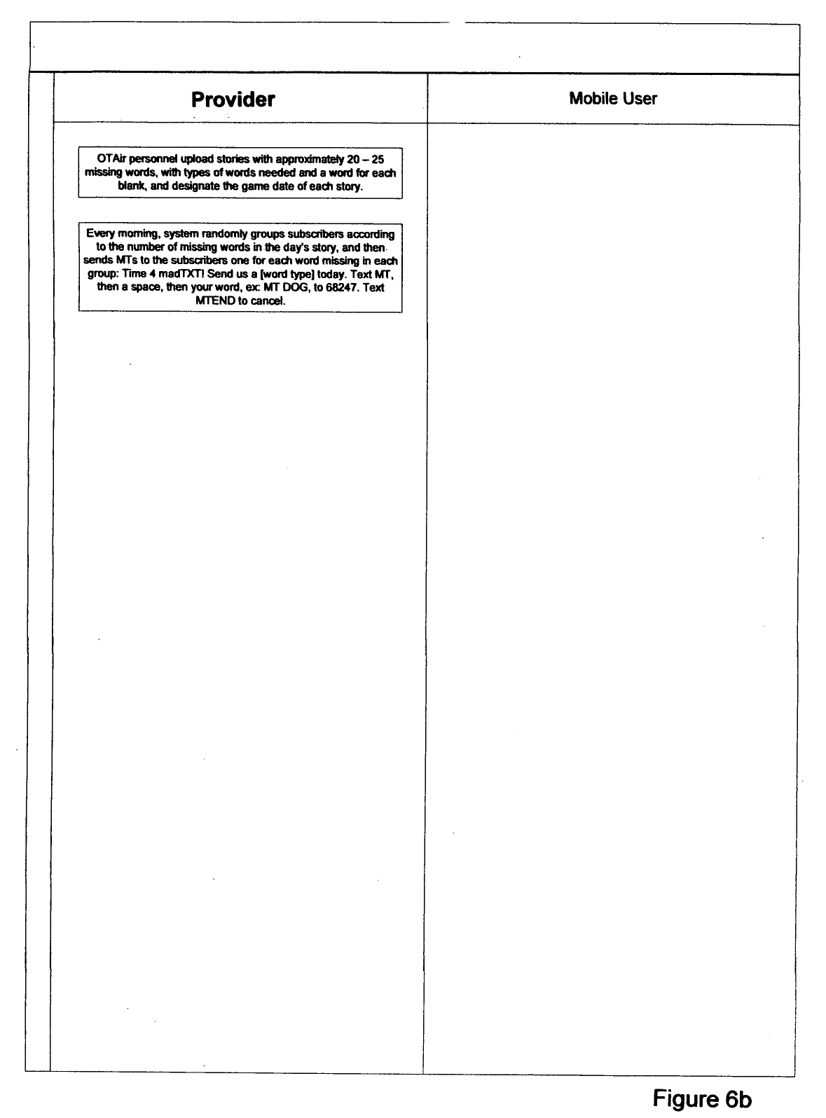

As an example of this embodiment, a provider offers an interactive game subscription for a monthly fee. The user is issued a username and a password. Each time the user accesses the provider's server by text messaging their credentials, she initiates an interactive game. FIGS. 6a-b graphically illustrate this example.

As a further example, a business operating in several states has a need to broadcast messages via text messaging to its sales staff. The messages can be one way to make a statement, or interactive in that the receiver of the text broadcast can make a response based on predefined response criteria.

The present invention enables the business through the provider of the service to define, create, submit, monitor, log and maintain, and track the results of the text broadcast in real-time, including a report capability. For instance, a business might need to get an urgent message to a group of employees, such as sales representatives who are mobile, to share important information or schedule meetings using text messaging in an interactive mode. Advertisers might use text broadcast to send messages on an immediate, scheduled one-time or scheduled recurring basis to mobile users who have opted-in to receive the service. Examples would include giving discounts or coupons to use a service, sending reminders of a scheduled event or inviting users to receive additional services or information.

Advertisers would log into the provider's system and access the text broadcast service. Once logged in, they would select the number of unique groups who will receive messages and place them into a tier arrangement showing any interrelations between the groups. For instance, a Tier 1 text broadcast would be sent to every group assigned to the business/advertiser category. A Tier 2 text broadcast would be sent to subordinates of the Tier 1 groups. The subordinates of Tier 1 groups might include geographical regions, or lines of business of the Tier 1 groups. A Tier 3 distribution would refine the text broadcast to those groups subordinate to the Tier 2 groups (such as cities, product line managers, sales staffs, etc). Once the group/tier structures have been defined, they can be populated with cell numbers of the recipients. Small lists can be keyed manually. Larger lists can be generated using a file structure and be imported into the provider's system or directly connected.

Multiple text methods can be defined for a particular broadcast event, if the message length is too large or there is a need to split up the message. If interactivity is required with the cell user, the interaction parameters will be defined with appropriate text responses. For instance, if the broadcast is to determine availability for a meeting, pressing a 1 would indicate that the person could attend the meeting, and pressing 2 indicates that they can not attend the meeting. The advertiser will be able to maintain its own text broadcast groups, tiers, cell numbers, delivery schedules, interactivity options and message content including service selections and payment processing. Reporting may include a log of each broadcast event showing delivery statistics and any responses obtained from the cellular user.

An example of alternatively using telephone numbers, names and words as keywords within an interactive messaging and media system would be to enhance the current Yellow Pages or any other directory of information. Each telephone number in the directory would have a symbol or symbols associated with it that would designate that number as having additional mobile information associated with it. For instance, a symbol, e.g. a logo, representing the business providing the service was placed next to a phone number in the directory, that would indicate to the viewer that the particular number in the directory, such as 555-111-1234, would be entered as a text message to a particular short code. After the interested party texted the keyword to the interactive messaging and media system, a unique response would be sent back to the user. In this way, a company or person can utilize their current telephone numbers, brand names or other publicly identifiable phone numbers, brand names and words to now become used in a totally different way by using them as keywords within an interactive system.

As another variant of the example above, a printed publication can have certain words, phrases or codes within the publication that can be used as keywords within an interactive messaging and media system to get more information. For instance, magazine article could have a certain word or phrase highlighted in a so that when texted into a mobile messaging system, the reader would be provided specific information for that word or phrase, similar to hypertext on an internet page. It is the assignment of the mobile device keyword to an inanimate number, name and word that allows the document, publication or directory to become interactive by using the mobile device as the input device and the interactive messaging and media system as the method to process the action and display results back on the phone.

An example of using consumer database data such as demographic, purchase behavior, interests and predictive indicators to tailor a unique, logical and specific response back to an individual who initiates a mobile inquiry based on data already stored for a particular cell phone number is the following:

A cell phone user initiates an SMS, MMS or similar message request keyword such as “Bike,” sent to a short code 68247 or similar telecommunications number to receive information on a bicycle offered for sale. The cell number of the user is then passed to, and matched against a database which contains demographic, purchase behavior, individual interests, financial information and predictive indicators that is available for that cell number. Based on the information in the consumer database, a more refined response is created for the request that relates their previous buying preferences and financial history to the product, information or service that they are interested in. If it turns out that the interested party would most likely be interested in a racing bike, used for long distances with a high quality and price based on their personal financial rating. The text or video message sent back to the user would be tailored to their interests based on the database and associated algorithms to select the answer. The response sent back to the user's cell phone could be a Tête De Course brand of bicycle offered by Racing Cycles, Inc., who also be a sponsor of the keyword campaign to drive business to their company.

An example of the process to use text messaging to purchase products, tickets and services which are about to spoil, become useless or worthless based on a time frame, or needs to be sold immediately, by using the immediate access of text, video and audio messaging using the mobile device is the following:

This invention is using an interactive messaging and media system to capture customers' interest for last minute tickets, and then using messaging to be able to broadcast availability of tickets out to customers, wherever they are via the mobile device, and consummate the transaction in a very short time, just before the event. The advantage for the theatre or sporting event, i.e., a promoting entity, is that it can wait until the last minutes before an event to release available tickets at a discount and make additional income.

A playhouse currently has individuals call into theaters or third party companies that broker last minute available tickets for theaters, shows, events, etc. This invention allows individuals to use the mobile device to initiate a request to a vendor of tickets to provide last minute discounts for seats that would normally remain unsold. A unique keyword such as AB12345, or other user-initiated mobile activity such as a mobile web site or MMS action, would be assigned to a particular show as the input action. The user would initiate the keyword or response to a short code or other telecommunication number to sign up for the opportunity to receive the last minute available tickets. All interested parties would initiate the mobile keyword or activity response to have the opportunity to receive the tickets. Three hours before curtain time on the day of the show, there are 50 available unsold seats for the show. The theatre would log into the interactive messaging and media system and broadcast messages out to the group of people who signed up to receive deals for that particular show and time with information as to how many tickets are available and where they are located. The interested party would reply to the message sent from the theatre as to how many tickets they want with the location. The ticket purchase could occur within the session by entering credit card information into a merchant account or by directing them via text to call a phone number.

The use of the present invent regarding ticket sale described in the previous paragraph is also be useful for perishable goods as well. For example, a merchant (promoting entity) may wish promote sale of a stock of fresh fruit before it was no longer marketable.

An embodiment utilizing an application programming interface to communicate with the system of Claim 3 is traffic alerts provided by a state's Department of Transportation, state police, department of motor vehicles or other like authority. The Department of Transportation system generates a list of accidents in the state categorized by highway, location and type of accident. A feed of this accident information is produced every 5 minutes 24 hours a day and 7 days a week. This feed of data is accessed by the interactive messaging and media system every five minutes and brought into its system. A web-based traffic alert signup form is available in the interactive messaging and media system for customers to sign-up for alerts by highways traveled and particular times of the day. Every time a traffic alert feed is obtained by the interactive messaging and media system, the particular traffic alerts are matched against the sign-up list of customers who have requested alerts for certain highways and time periods. When there is a match, the interactive messaging and media system will send a traffic alert text message to the customer.

A similar application of this embodiment is the broadcasting of mobile messages to a population alerting the recipients of a safety threat or missing person notices, e.g. “Amber alerts.” In particular, users could be warned in “real time” via their mobile devices of life threatening dangers requiring immediate action, such as an approaching tornado or a deranged gunman at large. Users could receive a call announced by a special ring tone with a short voice warning and/or a text message explanation of the danger. Users could rapidly send observations of the damage to the provider, who in turn, would inform the appropriate authorities. In addition to the registered users, the provider may wish to provide this warning service to all mobile device uses as a free public service.

Another embodiment of this invention is a search capability that is initiated from the mobile device. The search text is stored in the interactive messaging and media system, and then passed via a application programming interfaces, API, to the host web-based system that will perform the search as if it was typed directly into the web site. The search is performed on the host system and the result set is delivered back to the interactive messaging and media system via the API, a selection list is formatted and presented back to the mobile device as a selectable result set. The user would then select Result 1, 2 3, etc. and reply to the text message to get either more information on a particular item or to get the next set of results in the overall result set. This interactivity between the host system and the interactive messaging and media system can continue until the original query results in the search are exhausted. Coupons, information and media can be presented to the mobile device as the results are transferred from the host system to the mobile device via the interactive messaging and media system.

Yet another example of this invention relates to classified advertising. An external system displays classifieds for an online web site. The web site will access sign-up forms within the interactive messaging and media system for interested users to sign-up to receive text, video, picture or audio alerts directly to their mobile device when a classified ad name matches their criteria within the external web site. For instance, a person is interested in getting a mobile alert to their mobile device when any ad for a 1986 Ford Mustang is available. When a classified ad does appear that contains a reference to a 1986 Ford Mustang, the mobile alert is sent from the external system to the interactive messaging and media system via the API exchange available in this invention.

What is claimed is:

1. A system of interactive telecommunications involving text, multimedia, or both messaging whereby a mobile telecommunication device user may indicate interest in one or more products or services and receive multimedia content that may facilitate acquiring those products or services comprising:
one or more implementing servers coupled to a wide area computer network,
one or more databases and means for storing keyword-related, code-related, or free-form request information in one, all, or any combination of the databases, and
one or more mobile telecommunication devices coupled to one or more mobile telecommunication networks capable of capturing, transmitting and receiving data.

2. The system of claim 1 further comprising one or more websites to furnish additional information to the individual user, facilitate management of individual user accounts and preferences related to the messages transmitted between the user and the system or both.

3. The system of claim 1 wherein the data is input by means of keypad, voice, camera, microphone, and scanner, as well as other input devices activated by motion, external environmental conditions, touch, personal area wireless network technology, or any combination thereof.

4. The system of claim 1 further comprising one or more intelligence algorithms to impart search engine capability.

5. The system of claim 1 for further facilitating instant purchase of one or more products or services of interest to the user further comprising:
one or more application programming interfaces for exchanging sales order, billing and shipping information to/from the vendor of a product or service available for purchase, and
at least one means for the consumer to indicate desire to make a purchase via their mobile device, to authenticate their identity and authority to purchase, to optionally identify preferred payment method, to optionally adjust preferred shipping destination, and to receive confirmation of order fulfillment.

6. A method for interactively providing text or multimedia messaging of information to a mobile telecommunication device user of the system of claim 1 comprising the following steps:
Informing the user of information available on a service provider's server or servers,
Providing the user with a short code or phone number to access that information from a mobile telecommunication device and a keyword, or other code, to identify the particular information,
receiving at the service provider's server or servers a request for the information in the form of the provided short code and keyword or other code from a user interested in obtaining the information,
transmitting from provider's server or servers to the mobile device of the user the requested information in its most current version as a text or multimedia message, and
implementing one or more servers coupled to the Internet for receiving the keyword or other code from the input mobile device of the user to return appropriate information content.

7. A method for interactively facilitating commerce via a mobile device by an user of the system of claim 1 comprising the following steps:
Informing the user of information relating to a product or a service available on a service provider's server or servers,
providing the user with a short code or phone number to access that information from a mobile telecommunication device and a keyword, or other code, to identify the particular product or service,
transmitting from one or more service provider's server to the mobile device of the user via text message, voice response system, or other means a request for a security code to authorize the transaction,
receiving at one or more service provider's server the required security code from the mobile user,
transmitting the mobile user's pre-registered payment confirmation, shipping address and order information to the entity offering the product or service,
transmitting text message, e-mail, or both confirmation to the initiating mobile user,
receiving commands from the mobile user for balance and transaction history information and providing back to the mobile requested information via text messaging, email, or both, and
implementing server(s) coupled to the Internet for receiving keywords or other code from the input mobile device of the user to initiate and confirm commerce transactions, provide balance and transaction information and execute additional commands, such as toggling aliases, choosing shipping addresses, entering purchase comments, configuring frequently ordered product or service favorites and more.

8. The method of claim 7 comprising the additional step of personalizing or customizing the text or multimedia output based on historical, current behavioral, demographic or commercial data or any combination thereof available to the service provider based on the user initiating communications.

9. The method of claim 7 wherein the user is informed through the use of any combination of advertising, about which multimedia content is available, including but not limited to ringtones, wallpaper, screensavers, videos, mobisodes, podisodes, podcasts, games, music, lights, sounds, scents, motions, and tactile stimuli on or commanded from the provider's server and a short code to access that information from a mobile telecommunication device and a keyword or other code that identifies the particular product or service and further comprising the step of:
transmitting from at least one service provider's server to the mobile device of the user the requested content in its most current version or commands to initiate the delivery of sounds, motions, lights, scents, tactile feedback, or one or more of the above on the mobile telecommunication device.

10. The method of claim 7 wherein after the step of receiving at one or more service provider's server the required security code from the mobile user is added the further step of:
transmitting payment information to the user's pre-registered financial institution for checking EFT, debit card, credit card or gift card transactions.

11. The method of claim 7 wherein the security code is a PIN.

12. A method for broadcasting instant messages in a blog/RSS like manner via a mobile device by a user of the system of claim 1 comprising the following steps:
making one or more mobile user aware of TXTblogs, for which they can register,
providing each user with a short code to submit his or her registration request, and a keyword that identifies the particular TXTblog,
receiving at one or more service provider's server the user's request for registration to a TXTblog in the form of the short code and keyword from the user interested in obtaining the TXTblog,
optionally, facilitating one-time or regular subscription purchase confirmation from the mobile user for registration,
registering one or more mobile users as the contributors to the TXTblog and providing each user with a security code for authenticating a text posting to the TXTblog,
optionally, providing notification via a mobile, or stationary computing device, or both for one or more TXTblog moderators of the need to review and approve a TXTblog posting for distribution to registered subscribers,
receiving from the TXTblog moderators approval for the TXTblog posting to be distributed to registered subscribers,
transmitting the approved TXTblog posting to registered subscribers,
displaying the TXTblog content on service provider's website, and
implementing one or more server coupled to the Internet for receiving, processing and transmitting TXTblog subscription requests, postings, broadcasts approvals, broadcasts and comments.

13. A method for facilitating the creation and maintenance of a TXTwiki via text messaging; updatable online, using a mobile device, or both; moderated online, using a mobile device, or both; by a user of the system of claim 1 comprising the following steps:
making one or more mobile telecommunication users aware of TXTwikis, to which they can contribute, text, or both to receive updates from using the system of claim 1, the short code to submit their content or information request to and a keyword that identifies the particular TXTwiki and the function to be performed,
receiving at one or more service provider's server a request for registration to the TXTwiki in the form of the short code and keyword from the user interested in subscribing to any broadcast content,
optionally, facilitating one-time or regular subscription purchase confirmation from the user for registration,
receiving from one or more users one or more online submissions of content to the TXTwiki,
optionally, providing notification via mobile, or stationary computing device, or both for one or more TXTwiki moderators of the need to review and approve TXTwiki submissions to be distributed to registered subscribers,
receiving from the TXTwiki moderator approval for the TXTwiki submissions to be distributed as broadcast to registered subscribers,
transmitting approved TXTwiki broadcasts to registered subscribers,
displaying of the TXTwiki content on service provider's website, and
implementing one or more server coupled to the Internet for receiving, processing and transmitting the TXTwiki subscription requests, postings, broadcast approvals, broadcasts and comments.

14. A method for the dynamic, real-time creation of web-based alert or broadcast message subscriptions that individuals can opt-in and opt-out without the need to use their wireless device by users of the system of claim 1, comprising the following steps:
establishing one or more primary keyword in the system within a business' account,
optionally, creating one or more groups by an administrator of the business account,
creating by one or more forms and associates primary keywords by the administrator,
incorporating a standard web address containing arguments for the created form within any web page,
accessing the business' web page containing the web address for the form by one or more mobile telecommunication users entry of each user's mobile phone number either enters their or the business passes the user's pre-configured mobile phone number in the web address for the form,
selecting one or more keywords by the user that wishes to subscribe to broadcast messages for and configuring the desired days of the week and time range for the day during which the user wishes to receive broadcast messages, and
viewing by each user his or her schedule of alerts at anytime and altering or deleting subscriptions at any time.

15. The method of claim 14 wherein alert or broadcast message relates to warning of imminent damage.

16. A method for the dynamic, real-time creation and configuration of broadcasting messages to one or more mobile users by merging data, provided on an individual message basis or as part of a file containing numerous recipients, with a pre-configured text or email message template of the system of claim 1, comprising the following steps:
a business account administrator creates a text message template, email message template, or both, containing placeholders for data elements, within the system of claim 1,
a business account administrator configures the definition of fields to be provided within a file or individually in a transmission to the system of claim 1 indicating to the system of claim 1 the list of column headers in a file or XML tags in a XML file,
a business account administrator sets the text and/or email message template the system of claim 1 should use when processing a specific data file or stream,
optionally, a business account administrator configures the days, times, frequencies, login credentials and file location for files that the system of claim 1 needs to retrieve using FTP, or File Transfer Protocol,
optionally, a business account manager manually selects to upload a data file, browsing for the source data file from their computer or network and clicking to process it according to the message identifier in the file that matches a pre-configured data definition within the system of claim 1,

17. A method for interactive mobile messaging to initiate and receive information, alerts, coupons, notifications, and actions which are driven by the decision-making processes within a third-party system, using an Application Programming Interface within the interactive mobile messaging and media system comprising the following steps,
initiating specific keywords from a mobile telecommunication device to the interactive mobile messaging and media system would prompt application calls to specific external systems which would process the tasks associated with the input from the device,
processing rules within the external system could just accept the input from the device and keep the required actions within the external system, or the external system could initiate another interaction with the interactive mobile messaging and media system using the API and present a call to action or information back to the interactive mobile messaging and media system which would sent the required call to action back to the mobile device as information or asking for a further response,
transmitting output information, calls to action and further response requests will be sent from the external system via the API to the interactive mobile messaging and media system based on processing rules with the external system, which in turn sends the response to the mobile device, which can provide information or requests to initiate further interactivity with the external system.

18. A system of interactive telecommunications involving text messaging, multimedia messaging, or both whereby two more users can engage in two-way, interactive messaging-using a computer-based, internet-connected interface comprising:
one or more implementing servers coupled to a wide area computer network,
one or more databases and means for storing conversations and maintaining conversation state in one, all or any combination of the databases,
one or more websites and/or computer installed applications to facilitate the transmission and history of messages between the users,
one or more mobile telecommunication devices coupled to one or more mobile telecommunication networks capable of capturing, transmitting and receiving data input by means of keypad, camera, microphone, scanner, motion, external environmental conditions, touch, personal area wireless network technology, or any combination thereof.

19. A method for tailoring a unique, logical and specific response based on one or more consumer databases related to demographic, purchase behavior, interests and predictive indicators to an individual who initiates a specific inquiry based on one or more previously established databases for a cell phone number entered by the individual comprising the following steps,
correlating the incoming cell number of the individual with proprietary logic and decision-making process heuristics data which is also tied to a particular cell number as a database key within an interactive messaging system to provide a specific informational response, deal, coupon, incentive that is more likely to motivate the interested party to act and engage with the advertiser, company, event, and campaign,
saving responses of the individual to a particular mobile marketing campaign and documenting the actual redemption activity related to the campaigns to further enhance the decision-making processes of the model that drives the original mobile marketing response back to the individual.

20. A method to promote, notify, and sell available products, tickets, and services to one or more consumers wherein each consumer uses a mobile telecommunication device to send a specific keyword to an interactive mobile messaging system to a promoting entity, which can monitor its inventory of the available product, tickets and services that are available for that specific keyword and then notify the consumer via text, video or audio on the mobile telecommunication device that the product, tickets, and services can be purchased for a given price, comprising the following steps:
allowing a promoting entity to sell product, tickets and services which are about to spoil, become useless or worthless based on a time frame, or needs to be sold immediately, by using the immediate access of text, video and audio messaging using the mobile device, and then notify all or selected members of the group who have texted the specific keyword to receive the deals and specials on their phone,
providing the consumer with a means to sign up to receive deals and specials via a text keyword or mobile device response for deals and specials with the company or event, which can be temporary and of extreme short notice,
allowing the consumer to immediately respond, obtain more information and purchase the deals or specials using their mobile device.
